(19) United States
(12) Patent Application Publication
(10) Pub. No.: US 2026/0209889 A1
(43) Pub. Date: Jul. 23, 2026

(54) EXTRACTING AND RECOVERING METALS FROM CATHODE ACTIVE MATERIALS FROM LI-ION BATTERIES USING SULFIDE MINERALS AND CHEMICALS

(71) Applicant: MICHIGAN TECHNOLOGICAL UNIVERSITY, Houghton, MI (US)

(72) Inventors: Lei Pan, Houghton, MI (US); Ruiting Zhan, Houghton, MI (US)

(21) Appl. No.: 19/137,555

(22) PCT Filed: Dec. 18, 2023
(86) PCT No.: PCT/US2023/084607

§ 371 Date: Jun. 10, 2025

Related U.S. Application Data
(60) Provisional application No. 63/387,802, filed on Dec. 16, 2022.

(51) Int. Cl. C22B 7/00; C22B 3/08; H01M 10/54

(52) U.S. Cl. CPC C22B 7/007; C22B 3/08; H01M 10/54

(57) ABSTRACT

An exemplary method for recovering metals from a feed material may include processing feed material, mixing the processed feed material with one or more sulfide minerals or sulfide chemicals to generate a slurry, reacting the slurry and maintaining a target partial oxygen gas pressure, filtering solids from reacted slurry to form a pregnant leach solution, and precipitating one or more metals from the pregnant leach solution. The feed materials may comprise electrode active material recovered from Li-ion batteries.

### CROSS-REFERENCE TO RELATED APPLICATIONS

This application claims priority to U.S. Provisional Patent Application No. 63/387,802, filed on Dec. 16, 2022, the entire contents of which are incorporated herein by reference.

### STATEMENT OF GOVERNMENT INTEREST

This invention was made with government support under grant number DE-EE0010398 awarded by the Department of Energy, Energy Efficiency & Renewable Energy. The government has certain rights in the invention.

### TECHNICAL FIELD

The present disclosure relates to methods of extracting metals from black mass of shredded Li-ion batteries in aqueous solutions. The present disclosure also relates to extraction of valuable battery metals from a mixture of ore materials and black mass materials by balancing the composition ratio between sulfide and oxide compositions in the feed materials. The present disclosure also relates to methods that recover valuable commodity metals from pregnant leached solutions (PLS).

### INTRODUCTION

Battery powered devices are ubiquitous, and battery electrode materials include various metals. Removing and re-using metals from battery materials can be environmentally beneficial. Conventional acid leaching of battery metals (including lithium, nickel, cobalt, and manganese) from cathode active materials requires acid and reducing chemicals. The instant disclosure is directed towards recovering metals from various feed materials.

### SUMMARY

In some aspects, the techniques described herein relate to a method for recovering metals from a feed material, the method including: processing the feed material to generate a reactor feed having a Dᵥ50 particle size of less than 30 μm; mixing the reactor feed with one or more sulfide minerals or sulfide chemicals to generate a slurry; reacting the slurry in a reactor operating at a temperature of 125° C. to 225° C. and a pressure of 3,000 kPa to 10,000 kPa for 20 minutes to 120 minutes; maintaining a partial oxygen gas pressure of 500 kPa to 2,000 kPa in the reactor; filtering solids from the reacted slurry to form a pregnant leach solution; and precipitating one or more metals from the pregnant leach solution, wherein the one or more metals include iron, titanium, nickel, copper, cobalt, manganese, magnesium, calcium and lithium in the form of a sulfide, a hydroxide, and/or a carbonate.

In some aspects, the techniques described herein relate to a system for recovering metals from a feed material, the system including: a reactor; an ore material source in communication with the reactor; a black mass source in communication with the reactor; a sulfide material source in communication with the reactor; an oxygen source in communication with the reactor; a filtration unit in communication with an outlet of the reactor, the filtration unit configured to separate solid residue from a pregnant leached solution; a metal recovery unit in fluid communication with the filtration unit and configured to receive the pregnant leached solution, the metal recovery unit configured to generate intermediate metal products; and a metal refining unit in communication with the metal recovery unit, the metal refining unit configured to generate battery-grade metal products.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### BRIEF DESCRIPTION OF THE DRAWINGS

FIG. 1 is a schematic illustration of an exemplary system for recovering metals.

FIG. 2 is a flow chart of an exemplary method for recovering metals.

FIG. 3 shows an X-ray diffraction pattern of precipitated lithium carbonate (Li₂CO₃) products in an experimental example.

### DETAILED DESCRIPTION

The instant disclosure relates to systems, methods and techniques for extracting 90%+ of metals from black mass (a mixture of electrode active materials) from spent Li-ion batteries and scraps from manufacturing. Exemplary methods include cofeeding sulfide minerals and chemicals with the black mass. Both sulfide minerals and sulfide chemicals at a temperature of 125-225° C. in the presence of oxygen gas (O₂) generate reducing chemicals and acids, and both ingredients leach constituents from individual and mixed cathode active materials. The present disclosure includes a method that effectively leaches metals from nickel-bearing and cobalt-bearing ore minerals. The nickel-bearing and cobalt-bearing ore resources may include sulfide ore concentrate products, nickel-rich oxide minerals, and nickel-bearing silicate minerals. The present disclosure also relates to a purification and recovery of individual metals (Cu, Ni, Co, Ti, and Li) from pregnant leached solutions (PLS).

### I. Definitions

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “about” is used to indicate that exact values are not necessarily attainable. Therefore, the term “about” is used to indicate this uncertainty limit. The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5-1.4. The modifier “about” should also be considered as disclosing the range defined by the absolute values of the two endpoints. For example, the expression “from about 2 to about 4” also discloses the range “from 2 to 4.”

For the recitation of numeric ranges herein, each intervening number there between with the same degree of precision is contemplated. For example, for the range of between 6 and 9, the numbers 7 and 8 are contemplated in addition to 6 and 9, and for the range between 6.0 and 7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

### II. Theoretical Chemistry During Exemplary Processes

Without being bound by a particular theory, it is theorized that the following reactions take place during one or more of the processes and techniques characterized herein.

Conventional acid leaching of battery metals (including lithium, nickel, cobalt, and manganese) from cathode active materials (NMC, LMO, LCO, NCA, LFP) requires acid and reducing chemicals. These cathode active materials (CAM) are stable at high Eh and pH conditions. To effectively leach constituents from CAM, two prerequisites are to be met including 1) lowering solution pH and 2) lowering solution Eh (a measure of electric potential). Reducing chemicals, such as hydrogen peroxide (H₂O₂), to lower the oxidation-reducing potential (ORP) of the slurry to enable a leaching of all metals from the black mass. The chemical reaction for leaching of battery metals from lithium cobalt oxide (Li₂CoO₂) and lithium nickel-cobalt-manganese oxide (NMC) may be represented as follows:

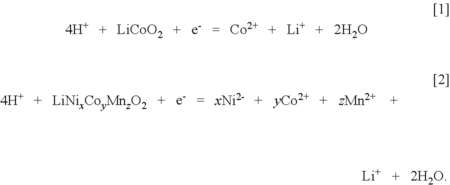

where H⁺ is a proton and e⁻ is an electron. Various inorganic and organic acids have been developed to effectively leach cathode active materials. In addition, reducing chemicals are needed. An example of the reducing chemicals is hydrogen peroxide (H₂O₂).

The present disclosure relates to the use of sulfide minerals/chemicals as both the source of reducing chemical and acid in the presence of oxygen gas (O₂). The sulfide (S²⁻) minerals may generate electron (e⁻) as described in the following equation:

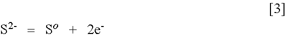

Sulfide in the presence of oxygen gas (O₂) are oxidized to sulfate and the reaction yields sulfuric acid (H₂SO₄). The chemical reactions with co-feeding both sulfide minerals/chemicals and cathode active materials in the presence of oxygen gas (O₂) are shown as follows:

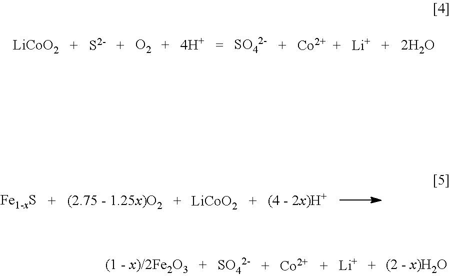

### III. Exemplary Systems

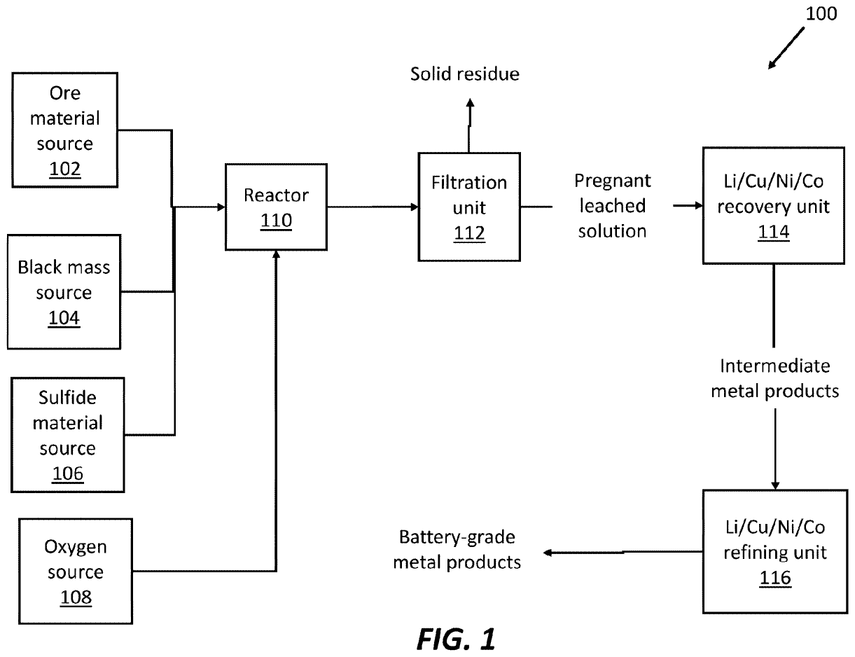

Various systems may be used to perform exemplary methods and techniques described herein. FIG. 1 is a schematic illustration of an exemplary system 100 for recovering metals. Exemplary system 100 includes ore material source 102, black mass source 104, sulfide material source 106, oxygen (O₂) source 108, reactor 110, filtration unit 112, Li/Cu/Ni/Co recovery unit 114, and Li/Cu/Ni/Co refining unit 116. Other embodiments may include more or fewer components.

Ore material source 102 is in communication with reactor 110. In some implementations, ore material source 102 may be configured to provide material to reactor 110 in batch operation. In some implementations, ore material source 102 may be configured to provide material to reactor 110 in continuous operation.

Broadly, ore material source 102 provides copper-, nickel-, and cobalt-bearing ore materials to reactor 110. Exemplary ore materials comprise sulfide minerals, oxide minerals (laterite minerals), and silicate minerals (such as olivine and serpentine). Sulfide minerals are a class of minerals including sulfide (S²⁻) and disulfide (S₂²⁻) as the major anion.

Common examples of sulfide minerals are chalcopyrite (CuFeS₂), pentlandite((Fe,Ni)₉S₈), pyrite (FeS₂), pyrrhotite(Fe₁₋ₓS), chalcocite (Cu₂S), millerite (NiS), Cattierite (CoS₂), cobaltpentlandite (Co₉S₈) and others. These sulfide minerals are naturally formed underground in the geological setting, and sulfide minerals are mined and concentrated to obtain concentrate products using various beneficiation methods such as froth flotation, magnetic separation, and gravity separation methods. Sulfide concentrate, particularly sulfide minerals with low concentration of valuable commodities, may be obtained by reprocessing the existing and legacy mine tailings.

The laterite mineral may be both a soil and a rock type rich in iron and aluminum (Al) and is a type of oxide mineral. Some of laterite deposits elevated concentration (1-3%) of nickel and cobalt.

Another oxide-type nickel/cobalt resource are polymetallic nodules sitting on the seabed floor. These polymetallic nodules, also called manganese nodule, are mineral concretions formed of concentric layers of iron and manganese hydroxides around a core. The polymetallic nodules may comprise 1-5% of nickel, cobalt, and copper combined.

Some silicate minerals, such as olivine and serpentine, may include 0.05%-0.2% of nickel and cobalt combined. These silicate minerals are the mine tailings left from the primary beneficiation of the underground deposits.

Black mass source 104 is in communication with reactor 110. In some implementations, black mass source 104 may be configured to provide nickel-bearing and cobalt-bearing recycled materials to reactor 110 in batch operation. In some implementations, black mass source 104 may be configured to provide material to reactor 110 in continuous operation.

Exemplary black mass material may be from lithium-ion batteries. For instance, exemplary black mass materials comprising nickel (Ni), cobalt (Co), lithium (Li), and copper (Cu) are from end-of-life Li-ion batteries, and scraps from Li-ion battery manufacturing. Black mass material may comprise black mass from Li-ion batteries or individual and mixed cathode active materials (CAM) from scraps. Generally, cathode active materials retrieved from Li-ion batteries comprise more than one type of cathode chemistries.

Exemplary feed materials may comprise one or more impurities or incidental elements, such as iron (Fe), aluminum (Al), sodium (Na), calcium (Ca), magnesium (Mg), silicon (Si), copper (Cu), with a trace amount of precious group metals (PGM). In some instances, exemplary feed materials may comprise impurities at no more than 20.0 wt %; no more than 1.0 wt %; or no more than 0.1 wt %.

Sulfide material source 106 is in communication with reactor 110. In some implementations, sulfide material source 106 may be configured to provide material to reactor 110 in batch operation. In some implementations, sulfide material source 106 may be configured to provide material to reactor 110 in continuous operation.

Broadly, sulfide material provided by sulfide material source 106 may comprise sulfide minerals and sulfide chemicals. Sulfide material is a class of compounds (chemicals, materials and minerals) comprising inorganic anion of sulfur with the chemical formular of S²⁻.

For instance, sulfide minerals may be obtained from mixed sulfide product (MSP) from nickel-bearing and cobalt-bearing resources. Sulfide minerals may be obtained by precipitating both nickel and cobalt from nickel-bearing and cobalt-bearing aqueous solution using hydrogen sulfide (H₂S) gases.

Sulfide in water may be present as S²⁻, H^{S-} or H₂S. Examples of soluble sulfide chemicals are potassium sulfide (K₂S) sodium sulfide (Na₂S) sodium hydrosulfide (NaHS), and hydrogen sulfide (H₂S) gas. Examples of insoluble sulfide minerals are pyrrhotite (Fe₁₋ₓS, x=0-0.2), pyrite (FeS), pentlandite ((Fe,Ni)₉S₈). In addition, the sulfide minerals and chemicals include a class of inorganic compound including disulfide anion (S₂²⁻). Table 1 shows an example of soluble inorganic sulfide chemicals (including sulfide gas).

TABLE 1
Examples of soluble inorganic sulfide chemicals.

| | | Sulfur |
|---|---|---|
| Sulfide Name | Chemical Formula | content wt. % |
| Sodium sulfide hydrate | Na₂S 9H₂O | 13.35% |
| Sodium hydrosulfide | NaHS xH₂O | 40.04% |
| hydrate | | |
| Potassium sulfide | K₂S | 29.08% |
| Potassium hydrosulfide | KHS | 44.43% |
| Hydro sulfide (Gas) | H₂S | 94.03% |
| Ammonium sulfide | (NH₄)₂S | 47.05% |
| Ammonium hydrosulfide | (NH₄)HS | 62.74% |
| Calcium sulfide | CaS | 44.45% |

Oxygen (O₂) source 108 provides oxygen (O₂) to reactor 110 and is in communication with reactor 110. In some implementations, oxygen (O₂) source 108 may be configured to provide material to reactor 110 in batch operation. In some implementations, oxygen (O₂) source 108 may be configured to provide material to reactor 110 in continuous operation.

Reactor 110 is configured to receive various materials and operate within predetermined temperature ranges. Reactor 110 may be configured for batch or continuous operation. In some instances, reactor 110 may comprise a plurality of reactors operating serially. In some instances, reactor 110 may comprise a plurality of reactors operating in parallel. Although not shown in FIG. 1, reactor 110 may also receive pH-adjusting material. For instance, reactor 110 may receive acid material from an acid source.

Filtration unit 112 receives an output stream from reactor 110 and separates solid residue from the reactor output. Filtration unit 112 is configured to generate solid residue as one output and pregnant leached solution as another output. Filtration unit 112 is in communication with an outlet of reactor 110.

Various types of filtration systems may be used for filtration unit 112. In some instances, filtration unit 112 comprises a plurality of filters arranged serially.

Li/Cu/Ni/Co recovery unit 114 receives pregnant leached solution from filtration unit 112. Li/Cu/Ni/Co recovery unit 114 generates intermediate metal products.

Li/Cu/Ni/Co refining unit 116 receives intermediate metal products from Li/Cu/Ni/Co recovery unit 114. Li/Cu/Ni/Co refining unit 116 generates battery-grade metal products.

### IV. Exemplary Processes

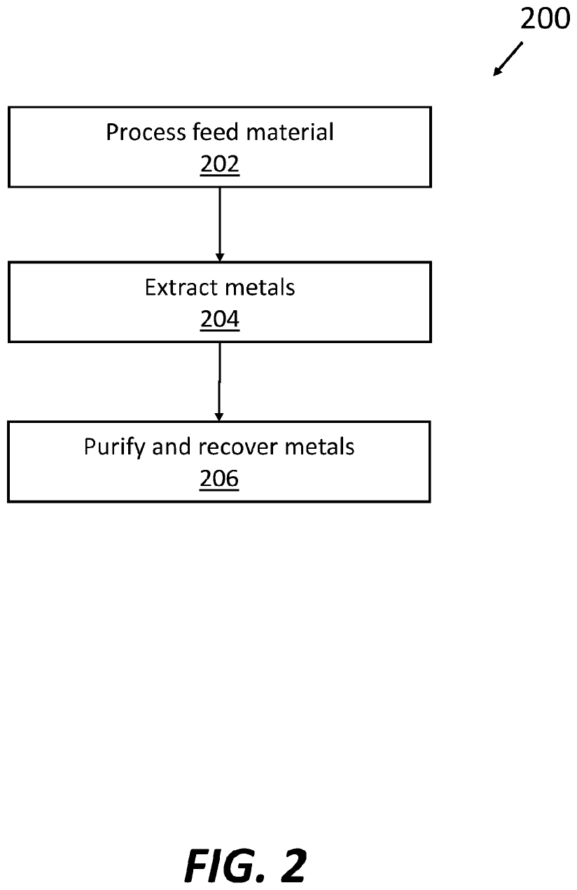

Various processes may be used to perform exemplary methods and techniques described herein. FIG. 2 is a flow chart of an exemplary method 200 for recovering metals. As shown, method 200 comprises processing feed material (operation 202), extracting metals (operation 204), and purifying and recovering metals (operation 206). Other embodiments may include more or fewer operations.

### A. Exemplary Processing Feed Material Operations

Exemplary method 200 may begin with one or more processing operations to prepare feed material (operation 202). Broadly, operation 202 may include one or more of: size reducing, filtering, drying, removing binders, removing adhesives, and generating a slurry. Various aspects of processing feed material (operation 202) are discussed below.

Cathode active materials (CAMs) are one of the feed materials provided to a reactor. Cathode active materials (CAM), used in state-of-the-art Li-ion batteries, include mixed lithium transitional metal oxides. Chemistry of cathode active materials include lithium cobalt oxides (LiCoO₂, LCO), lithium nickel-cobalt-manganese oxide (LiNiₓMn_{y}Co_{z}O₂, NMC, x+y+z=1), lithium nickel-cobalt-aluminum oxide (LiNiₓCo_{y}Al_{z}O₂, NCA, x+y+z=1), lithium iron phosphate (LiFePO₄, LFP), lithium manganese oxide (LiMnO₂, LMO), and many more. Therefore, mixed cathode active materials include valuable battery metals including lithium (Li), nickel (Ni), cobalt (Co), and manganese (Mn) as well as other valuable metals. Depending on types of cathode active materials, concentration of metal elements in cathode active material sample varies.

CAM may be obtained from scraps from manufacturing or end-of-life (EOL) Li-ion battery packs. Cathode active materials can be obtained by delaminating cathode active materials from aluminum current collectors using various size reduction methods in air or in water. This may be achieved by means of ball milling and hammer milling. Because the size of cathode active materials is smaller than that of the current collector after the milling process, a sieving process enables a concentration of cathode active material (powders) from current collectors.

Cathode active materials may be obtained as a part of components within black mass obtained from Li-ion batteries. Cathode active materials may be obtained by shredding and granulating Li-ion batteries into individual pieces. The black mass is the fine fraction of the shredded batteries, comprising anode active materials, cathode active materials (lithium transitional metal oxides, LTMOs), binders, 1-5% of aluminum (Al) and copper (Cu) as well as other metal contaminations. Other contaminants may be electrolyte such as lithium hexafluorophosphate (LiPF₆) and electrolyte solvents such as dimethyl carbonate. (DMC).

The particle size of the black mass may be reduced to 30 microns (μm) or less to enhance the extraction of battery metals from the black mass.

Processing feed material (operation 202) may include comminution of the feed material to a desired particle size. The Dᵥ90 size (90% of the total volume of materials in the sample is contained) of the feed material may be 250 μm or less. Size reduction may be performed using various methods. In some instances, size reduction may be conducted via ball milling, attrition milling, and/or high-shear blending.

Typically, the Dᵥ50 (50% of the total volume of materials in the sample is contained) particle size of the feed material is reduced to be no greater than 30 μm. In some instances, the Dᵥ50 particle size of the feed materials may be less than 30 μm to ensure the kinetics of leaching reaction is fast and all cathode active materials are exposed to the leaching solutions.

In various instances, the Dᵥ50 particle size of the feed material may be reduced to be between 1 μm and 30 μm; between 1 μm and 15 μm; between 15 μm and 30 μm; between 10 μm and 20 μm; or between 5 μm and 25 μm. In various instances, the Dᵥ50 particle size of the feed material may be reduced to be no greater than 30 μm; no greater than 25 μm; no greater than 20 μm; no greater than 15 μm; no greater than 10 μm; no greater than 5 μm; or no greater than 1 μm. In various instances, the Dᵥ50 particle size of the feed material may be reduced to be no less than 1 μm; no less than 5 μm; no less than 10 μm; no less than 15 μm; no less than 20 μm; no less than 25 μm; or no less than 30 μm.

In some instances, processing feed material (operation 202) may include removal of binders/adhesives. Removing binders includes thermally decomposing binders in the feed material, which may result in concentration of constituent portions of the feed material.

Removing binders may include heating the feed materials in an environment having a temperature of 400° C. to 500° C. In some instances, the feed materials may be burned at a temperature of 400° C. to 500° C. In various implementations, the feed materials may be positioned in an environment having a temperature between 400° C. and 500° C.; between 400° C. and 450° C.; between 450° C. and 500° C.; or between 425° C. and 475° C. In various implementations, the feed materials may be positioned in an environment having a temperature no less than 400° C.; no less than 425° C.; no less than 450° C.; no less than 475° C.; or no less than 500° C.

Removing binders may include burning the feed materials for 30-120 minutes. In various implementations, burning the feed materials may be performed for between 30 minutes and 120 minutes; between 30 minutes and 75 minutes; between 75 minutes and 120 minutes; or between 60 minutes and 120 minutes. In various implementations, burning the feed materials may be performed for no less than 30 minutes; no less than 45 minutes; no less than 60 minutes; no less than 75 minutes; no less than 90 minutes; no less than 105 minutes; or no less than 120 minutes. In various implementations, burning the feed materials may be performed for no greater than 30 minutes; no greater than 45 minutes; no greater than 60 minutes; no greater than 75 minutes; no greater than 90 minutes; no greater than 105 minutes; or no greater than 120 minutes.

Extraction of battery metals (operation 204) from black mass or mixed cathode active materials includes using sulfide chemicals, insoluble sulfide minerals, or a mixture of both. As described above, sulfide materials/minerals are a class of compounds (chemicals, materials and minerals) including inorganic anion of sulfur with the chemical formular of S²⁻.

The feed materials may be mixed with sulfide minerals and/or sulfide chemicals at a certain ratio, and the mixture is fed to the reactor in a slurry form. The solid concentration of the slurry may be in the range of 2-25% by weight (wt %). In various implementations, the solid concentration of the slurry may be between 2 wt % and 25 wt %; between 2 wt % and 14 wt %; between 14 wt % and 25 wt %; or between 5 wt % and 20 wt %. In various implementations, the solid concentration of the slurry may be no greater than 2 wt %; no greater than 5 wt %; no greater than 10 wt %; no greater than 15 wt %; no greater than 20 wt %; or no greater than 25 wt %. In various implementations, the solid concentration of the slurry may be no greater than 2 wt %; no greater than 5 wt %; no greater than 10 wt %; no greater than 15 wt %; no greater than 20 wt %; or no greater than 25 wt %.

In some instances, the solid feed materials comprise at least 60 wt % sulfide minerals/materials, where a remainder of materials in the solid feed may comprise nickel-bearing, cobalt-bearing, and lithium-bearing oxide and silicate minerals. In various implementations, the solid feed materials may comprise between 60 wt % and 80 wt %; between 60 wt % and 70 wt %; between 70 wt % and 80 wt %; or between 65 wt % and 75 wt % sulfide minerals/materials. In various implementations, the solid feed materials may comprise sulfide minerals/materials at no less than 60 wt %; no less than 65 wt %; no less than 70 wt %; no less than 75 wt %; or no less than 80 wt %. In various implementations, the solid feed materials may comprise sulfide minerals/materials at no greater than 60 wt %; no greater than 65 wt %; no greater than 70 wt %; no greater than 75 wt %; or no greater than 80 wt %.

In some instances, the solid feed materials comprise at least 20 wt % of sulfur(S). In various implementations, the solid feed materials may comprise between 20 wt % and 40 wt % sulfur(S); between 20 wt % and 30 wt % sulfur(S); between 30 wt % and 40 wt % sulfur(S); or between 25 wt % and 35 wt % sulfur. In various implementations, the solid feed materials may comprise sulfur(S) at no less than 20 wt %; no less than 25 wt %; no less than 30 wt %; no less than 35 wt %; or no less than 40 wt %. In various implementations, the solid feed materials may comprise sulfur(S) at no greater than 20 wt %; no greater than 25 wt %; no greater than 30 wt %; no greater than 35 wt %; or no greater than 40 wt %.

In various instances, the pH of the slurry prior to the reaction may be in the range of 4-11, depending on types, compositions, and amount of cathode active materials as well as sulfide minerals/chemicals feeding to the reactor.

The initial pH of the slurry may be lowered to be between 2-5 to enhance the leaching rate. In various implementations, the initial pH of the slurry may be adjusted to be between 2 and 5; between 2-4; or between 3-5. In various implementations, the initial pH of the slurry may be adjusted to be no less than 2; no less than 3; no less than 4; or no less than 5. In various implementations, the initial pH of the slurry may be adjusted to be no greater than 2; no greater than 3; no greater than 4; or no greater than 5.

In some instances, pH adjusting material may be combined with the slurry prior to providing the slurry to a reactor. In some instances, pH adjusting material may be combined with the slurry in a reactor. Various pH adjusting materials, such as acids, may be used. For example, sulfuric acid (H₂SO₄), or a combination of other acids, may be added to lower the pH.

In some instances, the oxidization-reducing potential (ORP) of the slurry provided to the reactor may be in the range of −700 mV to 200 mV, depending on dissolved sulfide concentration.

The black mass may comprise more than one type of cathode active materials and more than one type of anode active materials. The cathode active materials comprise various cathode active materials including lithium cobalt oxide (LCO), lithium nickel-cobalt-manganese oxide (NMC), lithium iron phosphate (LFP), lithium manganese oxide (LMO), as well as other types of cathode active materials. The anode active materials include graphite, silicone, as well as other types of anode active materials. Both anode and cathode active materials may mix with other additives including binders and conductive additives. In addition, many cathode active materials include propriety coatings, doping, and other additives. The mean particle size (Dᵥ50) of the black mass is less than 50 micrometers. The size reduction of the black mass minerals may be accomplished by comminution process including ball milling, vertical attrition mill, as well as other fine mills.

Disclosed herein are embodiments of the composition of feed materials into the autoclave for the leaching operation. The feed material comprises of mixed cathode active materials or black mass and sulfide compounds.

The molar ratio of soluble sulfide chemicals to cathode active materials in the slurry may vary from about 10:1 to about 2:1, depending on type of cathode active materials as well as the percentage of cathode active materials in the black mass. In various implementations, a molar ratio of soluble sulfide chemicals to cathode active materials in the slurry may be between 10:1 and 2:1; between 10:1 and 5:1; between 5:1 and 2:1; or between 8:1 and 4:1. In various implementations, a molar ratio of soluble sulfide chemicals to cathode active materials in the slurry may be no less than 2:1; no less than 3:1; no less than 4:1; no less than 5:1; no less than 6:1; no less than 7:1; no less than 8:1; no less than 9:1; or no less than 10:1. In various implementations, a molar ratio of soluble sulfide chemicals to cathode active materials in the slurry may be no greater than 2:1; no greater than 3:1; no greater than 4:1; no greater than 5:1; no greater than 6:1; no greater than 7:1; no greater than 8:1; no greater than 9:1; or no greater than 10:1.

For insoluble sulfide minerals, a molar ratio of insoluble sulfide minerals to cathode active materials in the slurry may vary from about 10:1 to about 5:1. In various implementations, a molar ratio of insoluble sulfide minerals to cathode active materials in the slurry may be between 10:1 and 5:1; between 10:1 and 7:1; between 7:1 and 5:1; or between 9:1 and 6:1. In various implementations, a molar ratio of insoluble sulfide minerals to cathode active materials in the slurry may be no less than 10:1; no less than 9:1; no less than 8:1; no less than 7:1; no less than 6:1; or no less than 5:1. In various implementations, a molar ratio between insoluble sulfide minerals to cathode active materials in the slurry may be no greater than 10:1; no greater than 9:1; no greater than 8:1; no greater than 7:1; no greater than 6:1; or no greater than 5:1.

### B. Exemplary Extracting Metal Operations

After processing feed material (operation 202), metals are extracted (operation 204) from the slurry. Leaching reactions may be conducted at a temperature between about 125° C. and about 225° C. In various implementations, leaching reactions may be conducted at a temperature between 125° C. and 225° C.; between 125° C. and 175° C.; between 175° C. and 225° C.; between 160° C. and 225° C.; between 190° C. and 210° C.; or between 180° C. and 225° C. In various implementations, leaching reactions may be conducted at a temperature no less than 125° C.; no less than 150° C.; no less than 160° C.; no less than 175° C.; no less than 185° C.; no less than 195° C.; no less than 205° C.; no less than 215° C.; or no less than 225° C. In various implementations, leaching reactions may be conducted at a temperature no greater than 125° C.; no greater than 150° C.; no greater than 160° C.; no greater than 175° C.; no greater than 185° C.; no greater than 195° C.; no greater than 205° C.; no greater than 215° C.; or no greater than 225° C.

During leaching reactions, a reactor pressure may be between about 3,000 kilopascal (kPa) and about 10,000 kPa. In various implementations, a reactor pressure during leaching reactions may be between 3,000 kPa and 10,000 kPa; between 3,000 kPa and 6,500 kPa; between 6,500 kPa and 10,000 kPa; between 8,000 kPa and 10,000 kPa; or between 5,000 kPa and 8,000 kPa. In various implementations, a reactor pressure during leaching reactions may be no less than 3,000 kPa; no less than 4,000 kPa; no less than 5,000 kPa; no less than 6,000 kPa; no less than 7,000 kPa; no less than 8,000 kPa; no less than 9,000 kPa; or no less than 10,000 kPa. In various implementations, a reactor pressure during leaching reactions may be no greater than 3,000 kPa; no greater than 4,000 kPa; no greater than 5,000 kPa; no greater than 6,000 kPa; no greater than 7,000 kPa; no greater than 8,000 kPa; no greater than 9,000 kPa; or no greater than 10,000 kPa.

Oxygen (O₂) gas may be provided to the reactor continuously or in batches during leaching operations. An oxygen partial pressure inside the reactor during leaching operations may be between about 500 kPa and about 2,000 kPa. In various implementations, an oxygen partial pressure inside the reactor during leaching operations may be between 500 kPa and 2,000 kPa; between 500 kPa and 1,250 kPa; between 1,250 kPa and 2,000 kPa; between 700 kPa and 1,800 kPa; or between 800 kPa and 1,700 kPa. In various implementations, an oxygen partial pressure inside the reactor during leaching operations may be no less than 500 kPa; no less than 750 kPa; no less than 1,000 kPa; no less than 1,250 kPa; no less than 1,500 kPa; no less than 1,750 kPa; or no less than 2,000 kPa. In various implementations, an oxygen partial pressure inside the reactor during leaching operations may be no greater than 500 kPa; no greater than 750 kPa; no greater than 1,000 kPa; no greater than 1,250 kPa; no greater than 1,500 kPa; no greater than 1,750 kPa; or no greater than 2,000 kPa.

Leaching operations may be conducted with a reaction duration between about 20 minutes to about 120 minutes. In various implementations, leaching operations may be conducted with a reaction duration between 20 minutes and 120 minutes; between 20 minutes and 70 minutes; between 70 minutes and 120 minutes; between 40 minutes and 100 minutes; or between 30 minutes and 60 minutes. In various implementations, leaching operations may be conducted with a reaction duration no less than 20 minutes; no less than 30 minutes; no less than 45 minutes; no less than 60 minutes; no less than 75 minutes; no less than 100 minutes; no less than 110 minutes; or no less than 120 minutes. In various implementations, leaching operations may be conducted with a reaction duration no greater than 20 minutes; no greater than 30 minutes; no greater than 45 minutes; no greater than 60 minutes; no greater than 75 minutes; no greater than 100 minutes; no greater than 110 minutes; or no greater than 120 minutes.

At least 90% by mass of battery metals (Li, Ni, Co, Mn) from individual cathode active materials may be extracted in the pregnant leach solution. In various instances, at least 90% by mass; at least 91% by mass; at least 92% by mass; at least 93% by mass; at least 94% by mass; or at least 95% by mass battery metals (Li, Ni, Co, Mn) from individual cathode active materials may be leachable with sulfide chemicals.

Exemplary methods may be capable of extracting and leaching mixed battery metals (Li, Ni, Co, and Mn) from mixed ore and black mass materials that include common metals including lithium (Li), nickel (Ni), cobalt (Co), and manganese (Mn). The feed resources (whether ore materials or black mass materials) include common valuable metals including lithium, copper, nickel, and cobalt. Once these targeted elements were leached in the leached solutions, the pregnant leach solution (PLS) include common valuable metals including lithium (Li), nickel (Ni), cobalt (Co), copper (Cu), and manganese (Mn). The targeted concentration of Li in the PLS may be in the range of 0.5-1.0 g/L, nickel (Ni) concentration in the PLS is 5.0-10.0 g/L, cobalt (Co) concentration in the PLS is 1.0-5.0 g/L, manganese (Mn) concentration in the PLS is 1.0-5.0 g/L, and copper (Cu) concentration in the PLS is in the range of 0.1-2.0 g/L.

The pH of the reactor output, the pregnant leached solution (PLS), may be in the range of 0.6-1.5.

### C. Exemplary Purifying and Recovering Metals Operations

After leaching operations (operation 204), exemplary method 200 includes purifying and recovering metals (operation 206) from a resulting mixture. Broadly, purifying and recovering metals (operation 206) includes various filtering and precipitation operations.

An initial stage of operation 206 may include filtering a resulting slurry to separate solid residue from pregnant leached solution (PLS). Various filtration units known in the art may be used to separate solids from pregnant leached solution (PLS). For instance, vacuum filtration and/or pressure filtration may be applied to remove solid from the filtrate solutions.

In various instances, a solid percentage of the filtered solids may exceed 80%, which may minimize the loss of valuable metals. For instance, a solids percentage of the filtered solids may be no less than 80%; no less than 83%; no less than 86%; or no less than 90%.

After removing solid residue, recovering metals (operation 206) from the pregnant leached solution may include various operations. Pregnant leached solutions (PLS) may comprise various metal elements including Li, Ni, Cu, Co, Mn, Mg, and Na, Ca, and other elements from mixed feed materials using the extraction technology disclosed herein. Within the PLS, in particular, lithium (Li), nickel (Ni), copper (Cu), cobalt (Co) may be valuable recovery targets. The concentration of the metals of interest may vary depending on feed materials and ratios. Exemplary metal recovery methods and solution purification methods may be flexible to adjust to various compositional concentrations.

The pH of the pregnant leached solution (PLS) may be in the range of 0.6-1.5. Recovery of individual elements may be accomplished by a series of precipitation processes.

In one stage, copper as well as trace amount of PGM (precious group metals) may be recovered and precipitated out in the form of sulfide minerals. Sodium hydrosulfide (NaHS) or sodium sulfide (NazS) may be added to precipitate the remaining copper by precipitating copper as copper sulfide (Cu₂S). The amount of NaHS is controlled to precipitate out at least 95% of copper while minimizing the precipitation of other valuable metals including nickel and cobalt. The targeted Eh of the pregnant leach solution (PLS) may be in the range of 150-250 mV.

Black powders may be precipitated out from the pregnant leach solution, and sulfide crystallization may occur for 5 to 10 minutes.

Exemplary copper precipitation processes may be conducted at temperatures between about 55° C. and about 65° C. In various instances, copper precipitation processes may be conducted at temperatures between 55° C. and 65° C.; between 55° C. and 60° C.; between 60° C. and 65° C.; or between 57° C. and 63° C. In various instances, copper precipitation processes may be conducted at temperatures no less than 55° C.; no less than 57° C.; no less than 59° C.; no less than 61° C.; no less than 63° C.; or no less than 65° C. In various instances, copper precipitation processes may be conducted at temperatures no greater than 55° C.; no greater than 57° C.; no greater than 59° C.; no greater than 61° C.; no greater than 63° C.; or no greater than 65° C.

Copper-rich sulfide precipitates may be removed by a filtration process. The copper-free filtrate solutions are oxidized in the presence of oxygen gas (O₂) to raise the redox potential (Eh) to above 350 mV.

The filtrate solution may be purified prior to nickel and cobalt precipitation processes. Removal of iron (Fe), sulfate ions (SO₄²⁻), aluminum (Al) from the filtrate may be performed by raising the pH. In some instances, the pH may be increased by adding calcium carbonate (CaCO₃) powders. The CaCO₃ powders may be added to the filtrate solutions while being agitated. The pH raises while materials are being precipitated. The amount of CaCO₃ added to the system is governed by the solution pH as described below.

Precipitation of iron, sulfate ions (SO₄²⁻), aluminum (Al) may be performed in multiple stages or one stage. A first stage of the precipitation process may include removing sulfate ions by precipitating out in the form of gypsum (CaSO₄). The pH of the solution may be increased to be between 2.0-2.5. The slurry may be filtered prior to subsequent precipitation processes.

A second stage of the precipitation process may include raising the pH to 3.0-4.0. This step may remove other elements including iron (Fe) and aluminum (Al) in the form of hydroxide materials and additional sulfate ions (SO₄²⁻). The two stages of the precipitation process may be combined.

The precipitate may then be filtered. The precipitate may be rinsed and ultrasonicated with dilute acid solutions at pH 4 two times to remove residue nickel (Ni), cobalt (Co) and lithium (Li)

### 1. Nickel (Ni) and Cobalt (Co) Recovery via Mixed Hydroxide Product

Both nickel (Ni) and cobalt (Co) from the filtrate solutions may be recovered by precipitation processes. Nickel (Ni) and cobalt (Co) may precipitate in the form of mixed hydroxide product (MHP) or mixed sulfide product (MSP). In precipitating both nickel and cobalt from filtrate solutions, a solid slurry of lightly burned magnesium oxide (MgO) may added to the filtrate solution. In some instances, the slurry may have a solids content between 10% and 30%.

The pH of the slurry may be slowly raised to 6.8-7.0 to precipitate both nickel and cobalt. The amount of magnesium oxide (MgO) added to the reactor is tuned based on the final pH (6.8-7.0) of the solution.

A mixed hydroxide product (MHP) may include about 40% of nickel (Ni) and cobalt (Co) combined. The remaining nickel (Ni) and cobalt (Co) may be recovered by adding quicklime (CaO). CaO slurry including 20% of quicklime may be slowly added to the solution.

Additional amounts of CaO may be added to the reactor to raise the solution pH to 7.2 to 7.5. The slurry may then be filtered to obtain the precipitate product including 20% of Ni/Co combined and about 10% of manganese (Mn) and other elements.

The remaining solution includes sodium (Na) and lithium (Li).

### 2. Nickel (Ni) and Cobalt (Co) Recovery via Mixed Sulfide Product.

Alternatively, nickel (Ni) and cobalt (Co) from the filtrate solution may be precipitated out by adding sodium hydrosulfide (NaHS). Fresh (NaHS) solution may be added to the mixture to precipitate out both nickel and cobalt (Co) as sulfide minerals. The pH of the solution may be at 6.5-7.5.

Approximately 100% by weight of NaHS to the nickel and cobalt remaining in the filtrate solution may be added. Both nickel (Ni) and cobalt (Co) may be precipitated out in the form of sulfide materials. The precipitate may then be filtered from the filtrate solution by a filtration process. The mixed sulfide product (MSP) obtained in this manner may include 50% by weight of nickel (Ni) and cobalt (Co) with less than 2% by weight of manganese (Mn).

### 3. Lithium (Li) Recovery

The remaining Mn, Mg, and Ca in the filtrate solution may be precipitated out by adding a basic material. In some instances, a basic material may comprise sodium hydroxide (NaOH). Other basic materials are contemplated. The pH of the slurry may be adjusted to 11-12, at which pH nearly all multivalent ions (e.g., Ca, Mg, Mn) are precipitated out. The remaining solution includes sodium (Na) and lithium (Li).

After recovering nickel and cobalt, lithium may be recovered. The filtrate may be heated to concentrate lithium to a concentration of 20 g/L or higher. Additional precipitate may be filtered to remove the precipitate including multivalent ions.

Precipitation of Li₂CO₃ may be conducted at a temperature between about 60° C. and about 90° C. In various instances, precipitation of Li₂CO₃ may be conducted at a temperature between 60° C. and 90° C.; between 60° C. and 75° C.; between 75° C. and 90° C.; or between 70° C. and 85° C. In various instances, precipitation of Li₂CO₃ may be conducted at a temperature no less than 60° C.; no less than 65° C.; no less than 70° C.; no less than 75° C.; no less than 80° C.; no less than 85° C.; or no less than 90° C. In various instances, precipitation of Li₂CO₃ may be conducted at a temperature no greater than 60° C.; no greater than 65° C.; no greater than 70° C.; no greater than 75° C.; no greater than 80° C.; no greater than 85° C.; or no greater than 90° C.

Sulfuric acid may be used to neutralize pH first to 6.5-7.5. After adjusting a pH to be 6.5-7.5, Na₂CO₃ may be added to the filtrate to obtain Li₂CO₃ precipitate products. In some implementations, the Li₂CO₃ purity may be greater than 95%. Additional purification may be needed to improve the purity of technical-grade Li₂CO₃ to battery-grade Li₂CO₃ products.

### V. EXPERIMENTAL EXAMPLES

Without limiting the scope of the instant disclosure, experimental examples of embodiments discussed above were prepared and the results are discussed below.

### Example 1. Extraction of Lithium Nickel-Manganese-Cobalt Oxide (NMC) Using Iron-Rich Sulfide Concentrate Products

This experimental example illustrated an extraction of metals from mixed cathode active materials and/or black mass using iron-rich sulfide product. This iron sulfide concentrate product included 20-30 wt % of iron, 20 wt % of sulfur, with less than 20 wt % of magnesium, sodium, aluminum, calcium, nickel, and cobalt combined. The mineralogy of this sulfide product was a mixture of pyrrhotite and pentlandite.

In this example, the major composition of the black mass was lithium nickel-cobalt-manganese oxide (LiNixCoyMnzO2, x+y+z=1, NMC). The percentage of Ni, Co, Mn, and lithium (Li) in the black mass sample was 25.3%, 14.0%, 21.0%, and 6.1% by weight, respectively. The NMC materials were recovered from Li-ion batteries. They were obtained by mechanically delaminating cathode active materials from current collectors (Al). The slurry passed through a 70-mesh sieve to obtain an undersize fraction, which was rich with NMC442. The slurry was filtrated, and the filter cake was dried. The NMC feed materials were heated at 500° C. for 2 hours in a muffin furnace to remove remaining PVDF binders and carbon additives. The mean particle size (Dᵥ50) of NMC422 was 11 microns.

A mixture of iron-rich sulfide minerals and recycled NMC at different feed ratios were fed to an agitated autoclave reactor (Parr instrument). The solid concentration was in the range of 5-20% by mass. The feed ratio between the sulfide concentration to the black mass by weight ranged from 5:1 to 10:1. The pH of the slurry was 4.0 to 6.0, depending on the feed ratio and solid concentration. The pH of the slurry may be lowered to 1.5-2.5 prior to the hydrothermal extraction process for the feed materials comprising 2:1 to 4:1 ratio by weight of sulfide concentrate to cathode active materials. The reaction temperature was 180-220° C., and the chamber pressure was 8274 kPa-12410 kPa. The oxygen overpressure in the autoclave reactor was 517 kPa-1034 kPa.

During the hydrothermal reaction process, oxygen gas (O₂) was continuously fed to the reactor. Oxygen gas reacts with sulfide minerals, oxidizing sulfide mineral to sulfate ions and generating acids (H⁺). Acids are consumed by cathode active materials. When no additional oxygen (O₂) gas was consumed by the reaction, the reaction ceased. The reaction lasted 30 minutes to 2 hours. The iron (Fe) from sulfide minerals was oxidized into hematite (Fe₂O₃).

Table 2 showed a 90%+leaching rate for Ni, a 95%+leaching rate for Co, and a 97%-99% leaching rate for Lithium.

TABLE 2
Leaching rate of individual elements from a binary mixture of nickel-bearing pyrrhotite concentrate
and NMC-based cathode active materials.

| | Sulfide | | | | | | |
|---|---|---|---|---|---|---|---|
| Trial # | (g) | NMC (g) | Temp (° C.) | Li (wt %) | Ni (wt %) | Co (wt %) | Mn (wt %) |
| 1 | 30 | 4.5 | 180 | 95.5% | 90.9% | 93.2% | 85.3% |
| 2 | 30 | 4.5 | 200 | 96.2% | 91.7% | 94.0% | 90.3% |
| 3 | 30 | 4.5 | 220 | 96.8% | 88.7% | 93.4% | 82.8% |
| 4 | 30 | 1.5 | 220 | 96.9% | 95.9% | 96.0% | 96.9% |
| 5 | 30 | 2.25 | 220 | 96.6% | 92.7% | 95.0% | 94.7% |
| 6 | 30 | 3.0 | 220 | 96.4% | 89.9% | 93.1% | 94.5% |
| 7 | 30 | 4.5 | 220 | 97.9% | 90.5% | 94.1% | 92.1% |
| 8 | 30 | 6.0 | 220 | 99.3% | 97.7% | 99.2% | 95.3% |
| 9 | 30 | 3.0 | 200 | 99.8% | 92.1% | 96.8% | 93.1% |
| 10 | 30 | 3.0 | 180 | 99.8% | 91.9% | 95.8% | 96.1% |

### Example 2 Extraction of Other and Mixed Cathode Active Materials and Black Mass Using Iron-Rich Sulfide Mineral Concentrate

In this example, leaching of other cathode active materials and mixed CAMs by cofeeding iron-rich sulfide products is demonstrated. Some of black mass samples contain aluminum, copper and other trace amounts of elements. Types of cathode active materials lithium cobalt oxide (LCO), lithium nickel-cobalt-manganese oxide (LiNixCoyMnzO2, x+y+z=1), lithium nickel-cobalt-aluminum (NCA), lithium manganese oxide (LMO), as well as others. The black mass feed materials contain not only mixed cathode active materials (CAMs), but also anode active materials, PVDF binders, copper (Cu), and aluminum. The mean particle size (Dᵥ50) of the feed cathode active materials (CAM) or black mass is less than 20 micrometers. The size reduction of the feed materials may be accomplished by comminution with ball mills, vertical ball mills. The feed materials contain 3-7% of lithium (Li), 10-26% of nickel (Ni), 5-30% of cobalt (Co), 1-20% of manganese (Mn), 0.1-8% of copper (Cu), 0.1%-5.0% of aluminum (Al). Both copper and aluminum may be present as the elemental form.

In this example, a mixture of iron-rich sulfide product and black mass was fed to a high-pressure autoclave reactor (Parr instrument). The solid mixture is mixed with deionized water (DI) to prepare 5-20% solid slurries. The pH of the feed slurries is ranged from 4.0 to 10.0, depending on the ratio between sulfide product to black mass in the feed. The pH of the slurry may be lowered to 1.5-2.5 for the feed materials having a 2:1 to 4:1 sulfide-to-oxide ratio. The slurry is fed to the autoclave reactor. The temperature of reaction is in the range of 200° C. The pressure inside the reactor maintained at 9653 kPa to 13790 kPa. Oxygen gas (O₂) is continuously fed into the reactor, and 517 kPa-1034 kPa of partial oxygen (O₂) pressure is maintained inside the reactor. The oxygen gas is consumed by the sulfide oxidation process.

Table 3 shows the extraction rate of various cathode active materials (NMC, LMO, LCO, LFP) and various black mass samples from commercial vendors. The mean particle size of the feed materials is 25 mm or below. The sulfide feed materials are iron-rich sulfide concentrate product. The 90% cumulative passing size is 25 μm or below. In each trial, 30 grams of sulfide product and 3-6 grams of cathode active materials (CAM) or black mass were fed together into the autoclave reactor. The sulfide-to-oxide ratio by weight in the feed materials is 5:1 and 20:1. The pH of the feed slurry is in the range of 4.0-8.0. Reaction temperature is 200° C. Oxygen (O₂) gas is continuously fed to the autoclave reactor, and oxygen partial pressure is maintained at 517 kPa-1034 kPa. Results showed that over 95% of lithium was extracted from different black mass. Leaching rate of Ni, Co, Mn exceeded 90%.

TABLE 3
Leaching rate of various cathode active materials and black mass from

| | Sulfide | Black | CAM | Temp | Time | Li | Ni | Co | Mn |
|---|---|---|---|---|---|---|---|---|---|
| Trial | (g) | Mass | (g) | (° C.) | (hrs) | (wt %) | (wt %) | (wt %) | (wt %) |
| 11 | 30 | NCA | 3 | 200 | 2 | 96.7% | 92.0% | 95.5% | 90.5% |
| 12 | 30 | LPF | 3 | 200 | 2 | 96.7% | — | — | — |
| 13 | 30 | LCO | 1.5 | 200 | 2 | 95.5% | — | 92.8% | — |
| 14 | 30 | BM | 1.5 | 200 | 2 | 97.7% | 93.5% | 95.0% | 95.3% |
| | | (1) | | | | | | | |
| 15 | 30 | BM | 3 | 200 | 2 | 99.8% | 91.0% | 96.1% | 97.5% |
| | | (2) | | | | | | | |

### Example 3 Extraction of Mixed Cathode Active Materials and Black Mass Using Sulfide Chemicals

Example 3 illustrates a method of leaching battery metals from individual cathode active materials or black mass by co-feeding with sulfide chemicals. These sulfide chemicals contain sulfide anions. Examples of sulfide chemicals include sodium sulfide (Na₂S), sodium hydrogen sulfide (NaHS), and hydrogen sulfide (H₂S). They are readily dissolved in water, forming sulfide (S²⁻) anion. Both sodium (Na⁺) ions and hydrogen (H⁺) ions in water. Sulfide anions are reducing chemicals. An addition of sulfide anions in the solution lowers the Eh of the slurry to below-500 mV.

In this example, a mixture of sulfide chemicals and cathode active materials (CAM) were added to a high-pressure autoclave. The pH of the slurry prior to feeding to the reactor is in the range of 8.0-12.0, depending on feed concentration and sulfide ratios. Both sodium sulfide (Na₂S) and sodium hydrogen sulfide (NaHS) are alkaline, while hydrogen sulfide (H₂S) gas is acidic. The pH of the feeding slurry may be lowered to 1.5-2.5 when the sulfide-to-CAM by weight ratio is 2 or below. Sulfuric acid (H₂SO₄) may be added to the slurry to lower the feed slurry. The slurry was reacted in the autoclave at a temperature of 200° C. The system pressure was 8274 kPa-12411 kPa. Oxygen (O₂) gas is continuously added to the reactor, and the oxygen overpressure is maintained at 517 kPa-1034 kPa. The oxygen gas is consumed by sulfide anions in the solutions and oxidized to sulfuric acids. When no additional oxygen gas (O₂) is consumed by sulfide oxidation process, a 30 minute to 1 hour residence time was needed for a full reaction.

Metals from cathode active materials are to be leached in the solution. The ratio between sulfide (S²⁻) to individual and mixed cathode active materials varies from 1:1 to 1.5:1. The solution pH prior the pressure oxidative leaching (POL) is 7.0-11.0. Oxygen (O₂) gas is continuously feeding to the reactor. The reaction ceased when no additional oxygen gas is consumed by the sulfide oxidation process. The slurry after the pressure oxygen leaching (PLS) reaction is filtered to separate solid residue from pregnant leached solution (PLS). Both PLS and solid residue are chemically analyzed by ICP-OES. Table 4 shows leaching rate of metals from mixed feed materials.

TABLE 4
Extraction rate of metals from various cathode active materials
using sodium sulfide.

| | CAM | | | Temp | | Li | Ni | Co |
|---|---|---|---|---|---|---|---|---|
| Trial | (g) | Type | S²⁻ (g) | (° C.) | Hours | (wt %) | (wt %) | (wt %) |
| 16 | 3 | NMC | 1.74 | 200 | 1 | 100% | 92.1% | 93.7% |
| 17 | 3 | NMC | 4.35 | 200 | 1 | 100% | 100% | 100% |
| 18 | 3 | NMC | 4.35 | 200 | 1 | 100% | 100% | 100% |
| 19 | 3 | BM | 4.35 | 200 | 1 | 100% | 99.5% | 99.1% |
| 20 | 4.6 | BM | 4.35 | 200 | 1 | 100% | 100% | 100% |

### Example 4. Co-Extraction of Battery Metals from Mixed Ore Materials and Black Mass Materials

Example 4 demonstrates a method of extracting nickel (Ni), cobalt (Co), and lithium (Li) from mixed feed resources. The feed materials are a mixture of ore materials and black mass materials. The ore materials include sulfide minerals containing nickel (Ni), cobalt (Co), copper (Cu). Many of these minerals are present in the form of sulfide minerals. The sulfide minerals are a class of minerals with sulfide (S²⁻) or disulfide (S₂²⁻) anions. The black mass materials include a mixture of cathode active materials from Li-ion batteries and scraps from manufacturing. The black mass is primarily the black mass from Li-ion batteries or the individual and mixed cathode active materials (CAM) from scraps. In this example, one of the feed materials is nickel concentrate product with 14% of nickel (Ni) by weight. Other feed material is iron-rich sulfide products, containing 40-50% of iron, 30% of sulfur(S), with 0.5-1.0% of nickel (Ni) and cobalt (Co) combined. The black mass materials are recycled NMC, which is recovered from Li-ion batteries. The NMC materials contain 50-60% by weight of Ni, Co, and Mn combined with 6.0%-7.0% of lithium (Li). Table 5 shows the composition of the feed materials tested in this example.

The mixed materials in a 10% solid slurry are fed to a pressure autoclave reactor. The pH of the slurry is 4.0-8.0. Table 5 shows the leaching rate of individual metal elements from mixed feed materials at different operating conditions. The operating temperature is 200° C. Oxygen (O₂) gas is continuously added into the reactor to oxidize sulfide minerals. The reaction lasted 1 hr. Table 5 shows leaching result. Results showed that leaching rate of all battery metals exceeded 90%, demonstrating a satisfactory extraction performance of constituents from mixed feed materials.

TABLE 5
Co-leaching of mixed feed materials from the feed materials.

| | Feed 1 | Feed | Feed 2 | Feed | Feed 3 | Feed 3 | Li | Ni | Co | Mn |
|---|---|---|---|---|---|---|---|---|---|---|
| Exp | Type | 1 (g) | Type | 2 (g) | Type | (g) | (wt %) | (wt %) | (wt %) | (wt %) |
| 21 | Fe | 20 | Ni | 10 | NMC | 3 | 98.1% | 92.2% | 96.5% | 96.1% |
| | sulfide | | Conc | | | | | | | |
| 22 | Fe | 20 | Ni | 20 | NMC | 4.5 | 99.5% | 93.8% | 97.7% | 98.4% |
| | sulfide | | Conc | | | | | | | |
| 23 | Fe | 20 | Ni | 20 | NMC | 6.0 | 99.5% | 91.7% | 96.6% | 97.9% |
| | Sulfide | | Conc | | | | | | | |
| 24 | — | — | Ni | 20 | NMC | 6.0 | 99.4% | 88.7% | 95.4% | 90.9% |
| | | | Conc | | | | | | | |
| 25 | Fe | 30 | Ni | 15 | NMC | 3 | 98.2% | 95.4% | 97.2% | 96.7% |
| | Sulfide | | Conc | | | | | | | |
| 26 | Fe | 30 | Ni | 15 | NMC | 4.5 | 97.8% | 92.5% | 94.9% | 96.8% |
| | Sulfide | | Conc | | | | | | | |
| 27 | Fe | 30 | Ni | 15 | NMC | 6.0 | 98.7% | 93.9% | 97.6% | 97.5% |
| | Sulfide | | Conc | | | | | | | |
| 28 | Fe | 30 | Ni | 10 | NMC | 6.0 | 99.4% | 93.7% | 97.5% | 98.8% |
| | Sulfide | | Conc | | | | | | | |
| 29 | Fe | 150 | Ni | 50 | NMC | 50 | 99.6% | 91.18% | 95.48% | 98.24% |
| | Sulfide | | Conc | | | | | | | |
| 30 | Fe | 100 | Ni | 100 | NMC | 50 | 98.6% | 93.73% | 97.02% | 97.63% |
| | Sulfide | | Conc | | | | | | | |

### Example 5. Co-Extraction of Battery Metals from Mixed Ore Materials and Black Mass Materials with Oxide Minerals

Example 5 demonstrates a method of extracting more than 3 feed materials containing both ore materials and black mass materials. The ore materials include both sulfide and oxide materials. Both types of resources, i.e., sulfide minerals and oxide minerals, include nickel (Ni), cobalt (Co), manganese (Mn). The mixture of ore materials includes ~50% of sulfide minerals and 50% of silicate and oxide minerals. The percentage of nickel in this feed materials is 2.0-2.3%. In this example, mixed feed materials in a 5-20% solid slurry are fed to the reactor. The feed materials are ball milled to an 80% cumulative passing size of 25 μm. The solid concentration is 10%. The reaction temperature is 200° C. Oxygen (O₂) gas is continuously fed to the autoclave reactor until no oxygen gas is consumed by the feed materials that contain sulfide minerals or chemicals. No additional acids were added to enhance the reaction. The iron (Fe) can be precipitated in the form of hematite (Fe₂O₃), while all other transitional metals are leached in the solutions. The overall leaching rate of metals of interest exceeds 90%. Table 6 shows the leaching rate of various metals from the mixed feed materials in this example. In these examples, the final pH of the slurry after the hydrothermal reaction is 0.50-0.85. Results showed that over 90% leaching rate of all metals from mixed feed materials.

TABLE 6
leaching of a mixture of nickel-bearing and cobalt-bearing feed materials including ore materials
and black mass materials.

| Exp | Fe Sulfide | | Ni Conc | Ni-bearing | pH | Li | Ni | Co | Mn |
|---|---|---|---|---|---|---|---|---|---|
| ID | (g) | NMC | (g) | Sulfide/Oxide (g) | (final) | (wt %) | (wt %) | (wt %) | (wt %) |
| 31 | 60 | 9 | 5 | 5 | 0.50 | 98.9 | 94.3 | 97.7 | 97.7 |
| 32 | 60 | 9 | 5 | 5 | 0.64 | 98.7 | 87.7 | 95.8 | 97.2 |
| 33 | 60 | 9 | 5 | 5 | 0.51 | 99.0 | 94.7 | 97.5 | 97.8 |
| 34 | 60 | 9 | 2.5 | 7.5 | 0.77 | 98.5 | 97.4 | 98.4 | 97.8 |
| 35 | 60 | 9 | 7.5 | 2.5 | 0.75 | 99.5 | 91.4 | 96.7 | 98.3 |

### Example 6. Precipitation and Recovery of Nickel and Cobalt from PLS

90-99% of metals of interest, including Li, Ni, Co, Cu, and Mn, are leached from mixed ore materials and black mass materials using exemplary processes described herein. The pregnant leached solutions (PLS) contain metals including lithium (Li), nickel (Ni), cobalt (Co), and copper (Cu). Other elements present in the pregnant leached solution (PLS) include sodium (Na), calcium (Ca), magnesium (Mg), zinc (Zn) and others.

Table 7 shows the concentration of constituents of several PLS examples used in this example. Lithium concentration is in the range of 0.3-1.0 g/L, Nickel concentration is in the range 3.0-10.0 g/L, cobalt concentration in the PLS is in the range of 1.0-3.0 g/L. The pH of the pregnant leach solution (PLS) is 0.5-1.2. The pregnant leach solution is free of solids. The total organic carbon contents are less than 0.1 g/L.

TABLE 7
Elemental composition of pregnant leach solution (PLS).

| Liquid | Li | Ni | Co | Mn | Cu | Fe | Ca | Mg | Na |
|---|---|---|---|---|---|---|---|---|---|
| samples | (g/L) | (g/L) | (g/L) | (g/L) | (g/L) | (g/L) | (g/L) | (g/L) | (g/L) |
| 1 | 2.44 | 11.52 | 4.20 | 6.27 | 0.48 | 25.00 | 0.358 | 1.83 | 0.68 |
| 2 | 1.93 | 12.67 | 3.45 | 5.15 | 0.71 | 14.20 | 0.260 | 1.61 | 0.28 |
| 3 | 1.70 | 9.42 | 3.05 | 4.41 | 0.79 | 32.99 | 0.142 | 1.24 | 0.08 |

The purification process used in recovering Ni, Co, and Li, and impurity removal (such as SO₄²⁻, Fe, Al, Mg, and others). The pregnant leach solution (PLS) was first neutralized by using calcium carbonate. Fresh grounded limestone (CaCO₃) was added to the solution. The particle size of the limestone should be less than 10 microns. The pH of the slurry was raised to 3.0-4.0. At this stage, part of iron (Fe) and majority of sulfate ion (SO₄²⁻) were removed by precipitating as gypsum (CaSO₄) and iron oxide hydroxide. The solid precipitate is filtered by filtration. The slurry is rinsed twice with DI water to remove any entrained metals of interest (including Li, Ni, Co).

Table 8 below shows the precipitation rate of various metals from the pregnant leach solution in the precipitate products at different pHs. Once the precipitate was removed by a filtration process, the filtrate solution is free of iron and aluminum. The filtrate can be further processed to recover valuable metals such as nickel and cobalt.

TABLE 8
Precipitation rate of various metals from the pregnant
leach solution (PLS).

| | Temp | Fe | Al | Ni | Co | Mn | Mg |
|---|---|---|---|---|---|---|---|
| pH | (° C.) | (wt %) | (wt %) | (wt %) | (wt %) | (wt %) | (wt %) |
| 5.03 | 60 | 99.7% | 100% | 7.8% | 4.7% | 2.9% | 2.3% |
| 4.40 | 60 | 99.8% | 100% | 2.7% | 1.5% | 1.0% | 0.9% |
| 3.59 | 60 | 99.3% | 100% | 2.2% | 1.5% | 1.1% | 0.9% |

The concentration of copper (Cu) in the pregnant leached solution may vary, depending on the Cu concentration in the feed materials. The removal rate of copper (Cu) in the precipitate product may be removed by adding sodium sulfide (Na₂S) and/or sodium hydrosulfide (NaHS). The total removal rate of copper is dependent on the amount of Na₂S added.

Both nickel (Ni) and cobalt (Co) from pregnant leach solution (PLS) are precipitated out in the form of mixed hydroxide product or mixed sulfide product. The mixed hydroxide product (MHP) is obtained by adding freshly prepared magnesium oxide (MgO). 20% MgO solid slurry is added to the filtrate, and the solution pH is adjusted to the range of 6.8-7.0. The crystallization process lasts 1.5-2.0 hours. About 70-80% of nickel (Ni) and cobalt (Co) is precipitated in the form of mixed hydroxide product (MHP). The filtrate solution after the first stage of MHP was neutralized by adding quicklime (CaO). The pH of the slurry during the scavenger Ni/Co precipitation process is 7.20-7.60. Above 99% of nickel (Ni) and cobalt (Co) were recovered. Table 9 shows the chemical composition of MHP product examples.

TABLE 9
Composition of high-grade MHP and low-grade MHP products.

| MHP | | | | | | | |
|---|---|---|---|---|---|---|---|
| Product | Ni | Co | Mn | Mg | Ca | Fe | Li |
| Example | (wt %) | (wt %) | (wt %) | (wt %) | (wt %) | (wt %) | (wt %) |
| 1 | 30.9% | 11.8% | 1.43% | 2.45% | 0.10% | <1.0% | 0.03% |
| 2 | 23.6% | 5.27% | 4.96% | 1.06% | 12.0% | 0.04% | 0.09% |

### Example 7. Purification—Precipitation of Lithium from Ni/Co-Free Pregnant Leach Solution

Pregnant leach solution after nickel and cobalt recovery contained lithium (Lithium) and sodium (Na) with a small amount of calcium, magnesium (Mg) and other elements. Table 10 shows the elemental composition of lithium-rich pregnant solution. The common impurities were calcium (Ca), magnesium (Mg), and sodium (Na). This example is to demonstrate a method of purifying pregnant leach solution by removing both calcium (Ca) and magnesium (Mg), while recovering lithium (Li) from the remaining pregnant leach solution (PLS) in the form of lithium carbonate (Li₂CO₃).

TABLE 10
Elemental composition of lithium-rich solution.

| | Li | Ca | Mg | Na | Fe | Ni | Co | Mn |
|---|---|---|---|---|---|---|---|---|
| PLS | (g/L) | (g/L) | (g/L) | (g/L) | (mg/L) | (mg/L) | (mg/L) | (mg/L) |
| 1 | 1.28 | 0.366 | 0.05 | 4.78 | <1 | <1 | <1 | <1 |
| 2 | 1.92 | 0.720 | 0.013 | 1.58 | <1 | <1 | <1 | <1 |
| 3 | 0.82 | 0.325 | 0.14 | 0.29 | <1 | <1 | <1 | <1 |

Prior to the lithium precipitation process, both calcium (Ca) and magnesium (Mg) were removed. 30% sodium hydroxide (NaOH) solution was added to raise the solution pH to 11.0, at which both calcium (Ca) and magnesium (Mg) are precipitated in the form of magnesium hydroxide (Mg(OH)₂) and calcium hydroxide (Ca(OH)₂). The lithium loss was 1-3%. The slurry was filtered to separate calcium and magnesium in solid residue, and the solution was rich in lithium. The lithium concentration prior to the evaporation process was 1.5-2.0 g/L, and sodium concentration was about 10 g/L. Lithium-rich pregnant leach solution was evaporated to concentrate the lithium to the concentration of 20 g/L. 40% sodium carbonate (Na₂CO₃) solution was added to the concentrated lithium solution. Lithium was precipitated out in the form of lithium carbonate (Li₂CO₃).

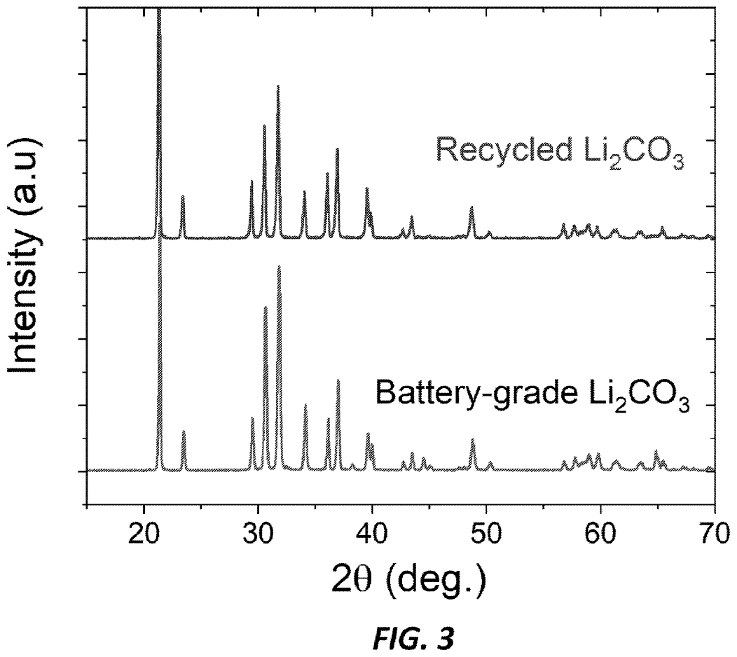

Table 11 shows the elemental composition of the Li₂CO₃ precipitate product. FIG. 3 shows an X-ray diffraction pattern of precipitated lithium carbonate (Li₂CO₃) products, labeled as “recycled Li₂CO₃.” Also shown in FIG. 3 for comparison is an X-ray diffraction pattern of commercially-available, battery grade lithium carbonate (Li₂CO₃), labeled as “battery-grade Li₂CO₃.”

TABLE 11
Elemental composition of precipitated Li₂CO₃ product.

| Product | Li (wt %) | Fe (wt %) | Mg (wt %) | Ca (wt %) | Na (wt %) |
|---|---|---|---|---|---|
| Li₂CO₃ | 18.4 | 0.019 | 0.007 | 0.04 | 0.43 |

For reasons of completeness, the following Clauses are provided:

Clause 1. A method for recovering metals from a feed material, the method comprising: processing the feed material to generate a reactor feed having a Dᵥ50 particle size of less than 30 μm; mixing the reactor feed with one or more sulfide minerals or sulfide chemicals to generate a slurry; reacting the slurry in a reactor operating at a temperature of 125° C. to 225° C. and a pressure of 3,000 kPa to 10,000 kPa for 20 minutes to 120 minutes; maintaining a partial oxygen gas pressure of 500 kPa to 2,000 kPa in the reactor; filtering solids from the reacted slurry to form a pregnant leach solution; and precipitating one or more metals from the pregnant leach solution, wherein the one or more metals comprise iron, titanium, nickel, copper, cobalt, manganese, magnesium, calcium and lithium in the form of a sulfide, a hydroxide, and/or a carbonate.
Clause 2. The method according to clause 1, the feed material comprising electrode active material recovered from Li-ion batteries.
Clause 3. The method according to clause 2, wherein the electrode active material includes one metal oxide or a mixture comprising lithium manganese oxide, lithium nickel-cobalt-manganese oxide, lithium cobalt oxide, lithium titanium oxide, lithium nickel oxide, lithium nickel-cobalt-aluminum oxide, lithium iron phosphate, lithium iron-manganese phosphate, and combinations thereof.
Clause 4. The method according to clause 2, wherein the feed material comprises sulfide minerals, oxide minerals, and silicate minerals.
Clause 5. The method according to clause 4, wherein the one or more sulfide minerals or sulfide chemicals comprise: potassium sulfide (K₂S) sodium sulfide (Na₂S) sodium hydrosulfide (NaHS), calcium sulfide (CaS), hydrogen sulfide (H₂S) gas, pyrrhotite (Fe₁₋ₓS, x=0-0.2), pyrite (FeS), pentlandite ((Fe,Ni)₉S₈), and combinations thereof.
Clause 6. The method according to clause 4, wherein removing binders comprising heating material in an environment at a temperature between 400° C. and 500° C. for 30 minutes to 120 minutes.
Clause 7. The method according to clause 1, wherein the slurry has a solids concentration between 2 wt % and 25 wt %.
Clause 8. The method according to clause 1, wherein solids in the slurry comprise at least 60 wt % sulfide material.
Clause 9. The method according to clause 1, wherein solids in the slurry comprise at least 20 wt % sulfur(S).
Clause 10. The method according to clause 1, further comprising adjusting a pH of the slurry to be between 2 and 5.
Clause 11. The method according to clause 1, wherein a molar ratio of soluble sulfide chemicals to cathode active materials in the slurry is between 10:1 and 2:1.
Clause 12. The method according to clause 11, wherein a molar ratio of insoluble sulfide minerals to cathode active materials in the slurry is between 10:1 and 5:1.
Clause 13. The method according to clause 1, wherein an oxidization-reducing potential (ORP) of the slurry is between-700 mV and 200 mV.
Clause 14. The method according to clause 1, wherein the pregnant leach solution comprises at least one of: 0.5-1.0 g/L of lithium (Li); 5.0-10.0 g/L nickel (Ni); 1.0-5.0 g/L cobalt (Co) 1.0-5.0 g/L manganese (Mn), and 0.1-2.0 g/L copper (Cu).
Clause 15. The method according to clause 1, wherein precipitating the one or more metals from the pregnant leach solution comprises adding sodium hydrosulfide (NaHS); and removing copper-containing species from the pregnant leach solution.
Clause 16. The method according to clause 15, wherein precipitating the one or more metals from the pregnant leach solution comprises adding calcium carbonate (CaCO₃) and increasing a pH of the pregnant leach solution to be between 3.0 and 4.0; and removing iron-containing species from the pregnant leach solution; and removing aluminum-containing species from the pregnant leach solution.
Clause 17. The method according to clause 1, wherein precipitating both nickel and cobalt from the pregnant leach solution comprises raising the pH of the pregnant leach solution to be between 6.5 and 7.5.
Clause 18. The method according to clause 1, wherein the reactor operating temperature is between 190° C. and 210° C. and wherein the reactor operating pressure is between 8,200 kPa and 10,000 kPa.
Clause 19. The method according to clause 1, wherein precipitating lithium from the pregnant leach solution by adding sodium carbonate (Na₂CO₃).
Clause 20. A system for recovering metals from a feed material, the system comprising: a reactor; an ore material source in communication with the reactor; a black mass source in communication with the reactor; a sulfide material source in communication with the reactor; an oxygen source in communication with the reactor; a filtration unit in communication with an outlet of the reactor, the filtration unit configured to separate solid residue from a pregnant leached solution; a metal recovery unit in fluid communication with the filtration unit and configured to receive the pregnant leached solution, the metal recovery unit configured to generate intermediate metal products; and a metal refining unit in communication with the metal recovery unit, the metal refining unit configured to generate battery-grade metal products.

1. A method for recovering metals from a feed material, the method comprising:
processing the feed material to generate a reactor feed having a Dᵥ50 particle size of less than 30 μm;
mixing the reactor feed with one or more sulfide minerals or sulfide chemicals to generate a slurry;
reacting the slurry in a reactor operating at a temperature of 125° C. to 225° C. and a pressure of 3,000 kPa to 10,000 kPa for 20 minutes to 120 minutes;
maintaining a partial oxygen gas pressure of 500 kPa to 2,000 kPa in the reactor;
filtering solids from the reacted slurry to form a pregnant leach solution; and
precipitating one or more metals from the pregnant leach solution, wherein the one or more metals comprise iron, titanium, nickel, copper, cobalt, manganese, magnesium, calcium and lithium in the form of a sulfide, a hydroxide, and/or a carbonate.

2. The method according to claim 1, the feed material comprising electrode active material recovered from Li-ion batteries.

3. The method according to claim 2, wherein the electrode active material includes one metal oxide or a mixture comprising lithium manganese oxide, lithium nickel-cobalt-manganese oxide, lithium cobalt oxide, lithium titanium oxide, lithium nickel oxide, lithium nickel-cobalt-aluminum oxide, lithium iron phosphate, lithium iron-manganese phosphate, and combinations thereof.

4. The method according to claim 2, wherein the feed material comprises sulfide minerals, oxide minerals, and silicate minerals.

5. The method according to claim 4, wherein the one or more sulfide minerals or sulfide chemicals comprise: potassium sulfide (K₂S) sodium sulfide (Na₂S) sodium hydrosulfide (NaHS), calcium sulfide (CaS), hydrogen sulfide (H₂S) gas, pyrrhotite (Fe₁₋ₓS, x=0-0.2), pyrite (FeS), pentlandite ((Fe,Ni)₉S₈), and combinations thereof.

6. The method according to claim 4, wherein removing binders comprising heating material in an environment at a temperature between 400° C. and 500° C. for 30 minutes to 120 minutes.

7. The method according to claim 1, wherein the slurry has a solids concentration between 2 wt % and 25 wt %.

8. The method according to claim 1, wherein solids in the slurry comprise at least 60 wt % sulfide material.

9. The method according to claim 1, wherein solids in the slurry comprise at least 20 wt % sulfur(S).

10. The method according to claim 1, further comprising adjusting a pH of the slurry to be between 2 and 5.

11. The method according to claim 1, wherein a molar ratio of soluble sulfide chemicals to cathode active materials in the slurry is between 10:1 and 2:1.

12. The method according to claim 11, wherein a molar ratio of insoluble sulfide minerals to cathode active materials in the slurry is between 10:1 and 5:1.

13. The method according to claim 1, wherein an oxidization-reducing potential (ORP) of the slurry is between-700 mV and 200 mV.

14. The method according to claim 1, wherein the pregnant leach solution comprises at least one of:
0.5-1.0 g/L of lithium (Li);
5.0-10.0 g/L nickel (Ni);
1.0-5.0 g/L cobalt (Co)
1.0-5.0 g/L manganese (Mn), and
0.1-2.0 g/L copper (Cu).

15. The method according to claim 1, wherein precipitating the one or more metals from the pregnant leach solution comprises adding sodium hydrosulfide (NaHS); and
removing copper-containing species from the pregnant leach solution.

16. The method according to claim 15, wherein precipitating the one or more metals from the pregnant leach solution comprises adding calcium carbonate (CaCO₃) and increasing a pH of the pregnant leach solution to be between 3.0 and 4.0; and
removing iron-containing species from the pregnant leach solution; and
removing aluminum-containing species from the pregnant leach solution.

17. The method according to claim 1, wherein precipitating both nickel and cobalt from the pregnant leach solution comprises raising the pH of the pregnant leach solution to be between 6.5 and 7.5.

18. The method according to claim 1, wherein the reactor operating temperature is between 190° C. and 210° C. and wherein the reactor operating pressure is between 8,200 kPa and 10,000 kPa.

19. The method according to claim 1, wherein precipitating lithium from the pregnant leach solution by adding sodium carbonate (Na₂CO₃).

20. A system for recovering metals from a feed material, the system comprising:
a reactor;
an ore material source in communication with the reactor;
a black mass source in communication with the reactor;
a sulfide material source in communication with the reactor;
an oxygen source in communication with the reactor;
a filtration unit in communication with an outlet of the reactor, the filtration unit configured to separate solid residue from a pregnant leached solution;
a metal recovery unit in fluid communication with the filtration unit and configured to receive the pregnant leached solution, the metal recovery unit configured to generate intermediate metal products; and
a metal refining unit in communication with the metal recovery unit, the metal refining unit configured to generate battery-grade metal products.
